(19) United States
(12) Patent Application Publication
(10) Pub. No.: US 2011/0002565 A1
(43) Pub. Date: Jan. 6, 2011

(54) BEARING BUSH

(75) Inventors: Caroline Ambroise, Duesseldorf (DE); Lars-Boris Kuentzler, Krefeld (DE); Juergen Hartman, Willich (DE)

Correspondence Address: LARSON NEWMAN & ABEL, LLP, 5914 WEST COURTYARD DRIVE, SUITE 200, AUSTIN, TX, 78730, US

(73) Assignee: SAINT-GOBAIN PERFORMANCE PLASTICS PAMPUS GMBH, Willich (DE)

(21) Appl. No.: 12/790,186

(22) Filed: May 28, 2010

Related U.S. Application Data
(63) Continuation-in-part of application No. PCT/EP2008/065053, filed on Nov. 6, 2008.

(30) Foreign Application Priority Data
Nov. 8, 2007 (EP) 07120298.0
Dec. 21, 2007 (EP) 07123999.0

(51) Int. Cl. F16C 27/00; F16C 33/24; B21D 3/00

(52) U.S. Cl. 384/222; 411/366.1; 403/404; 411/504; 72/112

(57) ABSTRACT

The invention relates to a bearing bush (1) comprising an essentially cylindrical bush section (1a) and at least one radial flange (1b) arranged on an axial end of said cylindrical bush section (1a). The bearing bush according to the invention is characterized in that the at least one flange (1b) has a mushroom shaped cross section so as to allow axial and radial tolerance compensation in a bearing assembly. Furthermore the invention relates to a bearing assembly and a forming tool for producing a bearing bush.

The invention relates to a bearing bush comprising an essentially cylindrical bush section and at least one radial flange arranged on an axial end of said cylindrical bush section. Furthermore, the invention relates to a bearing assembly and to an advantageous use of the bearing assembly. Further, the invention relates to a bordering tool for producing a flange on a bearing bush.

Bearing bushes, especially sliding bearing bushes, are widely used in various technical fields, e.g. in automotive engineering. In particular, bearing bushes are used in door hinges, pedal linkage systems, shock absorbers, hood, trunk and sun-roof mechanisms as well as in brake, suspension and transmission assemblies. Another important application is the use of sliding bearing bushes in automotive seat linkages. Those automotive seat linkages are generally designed with little or no clearance to allow for a smooth and noiseless movement of the seat elements relative to each other. If the pivot assembly is too tight then unwanted friction and torque are generated. If the pivot assembly is too lose then noise vibrations and rattling might appear.

The overall clearance of a pivot assembly is a direct function of the tolerance of the individual assembly components, namely the pin or screw with nut, the housing (typically the linkage itself) and the sliding bearing.

A tight assembly tolerance is only made possible when all the components have own tight tolerances, or when the components are selectively matched to each other.

A solution to achieve a very small clearance despite the individual tolerances of the assembly components would be to introduce an additional element allowing compensation of the tolerances both an axial and in radial direction. The compensation could be achieved through deformation of this very element. For example, spring washers could be used to compensate the axial tolerance. Likewise, a tolerance ring could also compensate the clearance in radial direction. However, this solutions increase the number of components and therefore the total cost of the assembly.

Another solution currently practiced consists of using a sliding bearing bush with a V-shaped flange. i.e. the bearing bush is of funnel shape. The V-shaped flange acts as a spring and helps to compensate tolerances in the axial direction. However, this bearing design does not allow a radial tolerance compensation. Furthermore, V-shaped bearings are bound to tangle to each other when transported in bulk thus generating feeding issues at the pivot assembly line.

It is thus an object of the invention to provide a bearing bush having at least one radial flange the bearing bush being of simple shape thereby allowing for both axial and radial tolerance compensation in a bearing assembly. It is a further object of the invention to provide a bearing assembly with axial and radial tolerance compensation. It is a further object of the invention to provide a forming tool for forming the flange of a bearing bush.

The first object is achieved according to the invention by a bearing bush comprising an essentially cylindrical bush section and at least one radial flange arranged on an axial end of said cylindrical bush section, the bearing bush being characterized in that the at least one flange has a mushroom shaped cross section so as to allow axial and radial tolerance compensation in a bearing assembly.

The tolerance compensation is achieved via the at least one mushroom shaped flange. The mushroom shape allows the flange to act as a spring washer thus compensating for axial clearance through spring back effect. This mushroom shape further allows also to prestress and partly deform the bearing bush on its cylindrical surface during assembly. The resulting deformation is able to compensate for the radial clearance between the housing/bearing bush/pin in a bearing assembly.

According to an advantageous embodiment of the invention the bearing bush is made of a sliding bearing material. In turn, the sliding bearing material may comprise a metallic support and an overlay forming the sliding layer. During use of the bearing bush in a bearing assembly the overlay is in sliding contact with the pin thus ensuring low friction and reduced maintenance.

Preferably, the overlay contains a plastic material as a sliding material, in particular a high-temperature plastic material, preferably a fluoroplastic material, especially Polytetrafluorethylene, Polyimide, Polyamidimide, Polyvinylidenfluoride, Perfluoralkoxy-Copolymer, Polyetherketone, Polyethylene, preferably Polyethylene of ultra high molecular weight, or a combination thereof. The metallic support may consist of steel, in particular special steel, copper, titanium, bronze, aluminium or an alloy thereof. These materials ensure the right degree of rigidity of the bearing material to allow good tolerance compensation.

According to a further advantageous embodiment the sliding bearing material further comprises a reinforcement material. This may have an open structure. In this case the overlay material may at least partly fill the openings of the reinforcement material, which makes the overlay stronger and more tear-resistant. Reinforcement materials having an open structure may be a fabric, in particular a wire mesh, an expanded metal, a fleece, in particular a metal fleece, a metal foam, a perforated plate and/or a metallic substrate and a series of raised structures formed integrally therewith and extending orthogonally therefrom. The reinforcement material may consist of metal, in particular steel, preferably special steel, bronze, copper, chrome, nickel, zinc, zinc-ferrous alloy, zinc-nickel alloy and/or aluminium or alloy thereof.

The bearing bush may be produced in various ways. It may be a deep-drawn bearing bush as well as a wrapped bearing bush shaped from an initially flat material. In the latter case the bearing bush has an axial slit wherein the slit may be inclined relative to a longitudinal axis of the bearing bush and wherein the slit may be straight or have a special design like Z-shape or omega-shape.

According to another embodiment the bearing bush has a flange with a mushroom shaped cross section on one axial end of the bush section and a tapered end section on the other axial end so as to facilitate insertion of the bearing bush into a housing.

According to an alternative embodiment of the invention the bearing bush in assembled condition, i.e. when integrated in a bearing assembly, has two flanges each having a mushroom shaped cross section and each being disposed on one axial end of the bush section. A bearing bush having two flanges is particularly suitable for both axial and radial tolerance compensation in a bearing assembly. In addition, a bearing bush having two flanges is axially securely fastened to the housing. It is to be understood that a bearing bush having a mushroom shaped flange on one end and e flat or V-shaped flanged on the other end is also possible.

A particularly effective axial and radial tolerance compensation in a bearing assembly is achieved when the ratio of the height of the mushroom cross section, i.e. the extent of the mushroom cross section in the longitudinal direction of the bearing bush, and the thickness of the bearing material is 1.5 to 2. For example, when the thickness of the bearing material is 0.5 mm the height of the mushroom cross section may be 0.75 mm so that the ratio defined above is 1.5.

The radial extent of the mushroom shaped flange is preferably adapted to the inner diameter of the bush section. According to a preferred embodiment the ratio of the flange diameter and the inner diameter of the bush section is approximately 1.0 to 2.0, in particular approximately 1.4 to 1.6. In case of a deep-drawn bush the ratio of the flange diameter and the inner diameter of the bush section is larger than 1.0.

A second aspect of the invention relates to a bearing assembly comprising at least one housing, a bearing pin and a bearing bush disposed between the at least one housing and the bearing pin, wherein the bearing bush is designed according to any one of claims 1 to 16. The advantages of the bearing bush set out in detail above also apply for the bearing assembly according to the invention. In particular, the bearing assembly ensures a high degree of both axial and radial tolerance compensation.

A third aspect of the invention relates to automotive applications comprising at least one bearing assembly according to claim 19 or 22 for hinged connection of individual components. The use of the bearing assembly comprising a bearing bush according to the invention ensures smooth and noiseless and vibration free movement of the individual linkage elements relative to each other.

A fourth aspect of the invention relates to a forming tool for producing a flange on an axial end of a bearing bush having a cylindrical bush section, wherein the forming tool comprises a forming mandrel having a circumferential shoulder (dead stop) and a counter tool having a cylindrical inner surface surrounding the cylindrical bush section of the bearing bush to be bordered, wherein the counter tool has an annular end face serving as stop face for the mandrel, wherein the circumferential shoulder of the mandrel and the annular end face of the counter tool are formed such that the flange of the bearing bush is formed with a mushroom shaped cross section.

The forming tool according to the invention allows for a precise manufacture of the mushroom shaped flange with a high degree of reproducibility.

it is to be understood that a conical shape of the bush section of the bearing bush in combination with at least one flange having a mushroom shaped cross section also allows for radial and axial tolerance compensation and is thus within the scope of the invention.

The invention is explained in more detail below with reference to the drawings representing an embodiment, in which:

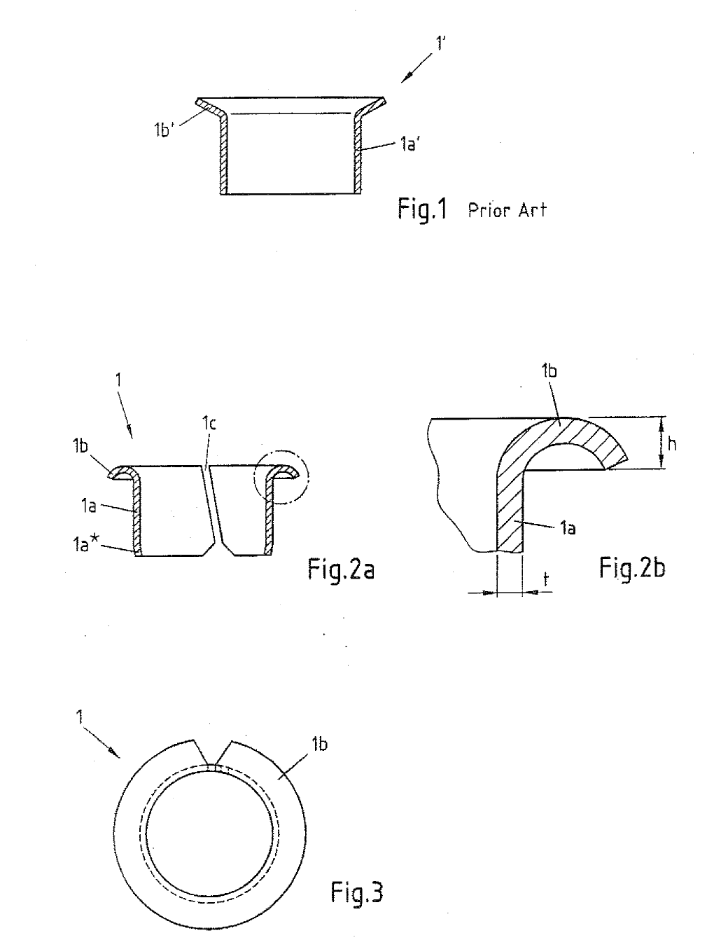

FIG. 1 shows a bearing bush according to the prior art in a longitudinal sectional view;

FIG. 2a,b shows a bearing bush having one flange with a mushroom shaped cross section according to the invention and a detail of the flange;

FIG. 3 shows the bearing bush of FIG. 2 in a top view;

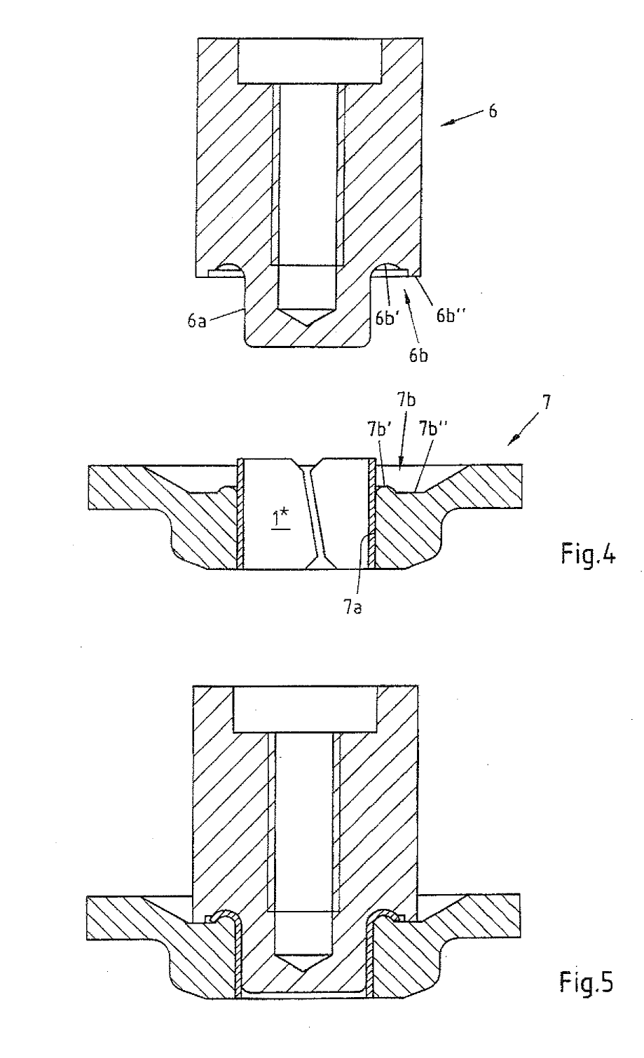

FIG. 4 shows a forming mandrel and a counter tool holding a bearing bush in the home position of the forming tool in a sectional view;

FIG. 5 shows the forming mandrel and the counter tool of FIG. 5 in a terminal forming position in a sectional view;

FIG. 6 shows a forming tool for producing a second flange on a bearing bush inserted into the housing of a bearing assembly in a home position in a sectional view;

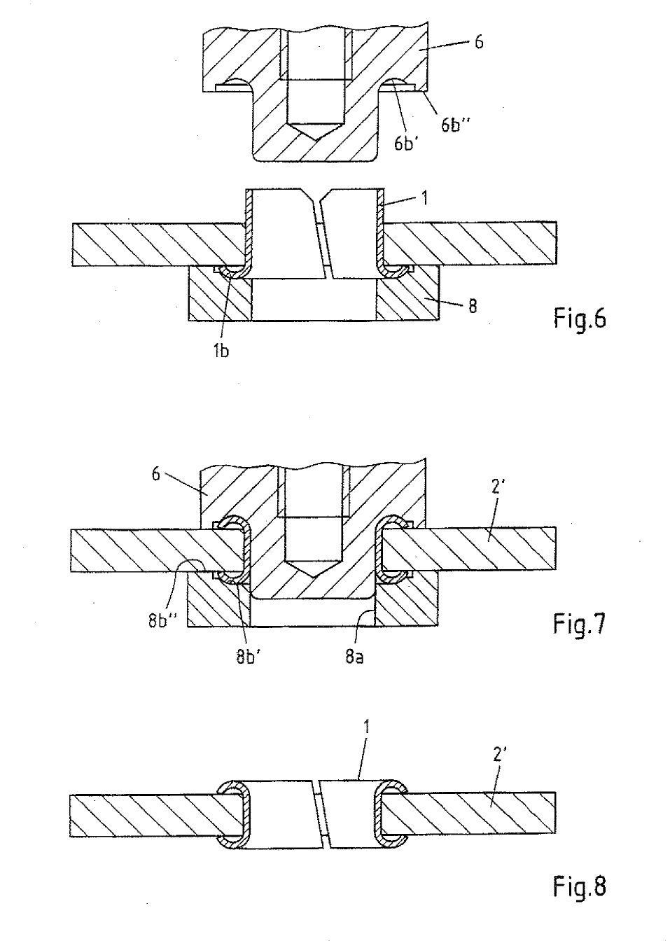

FIG. 7 shows the forming mandrel and the counter tool of FIG. 7 in a terminal forming position in a sectional view; and

FIG. 8 shows the bearing bush of FIG. 7 in the housing after completion of the forming process.

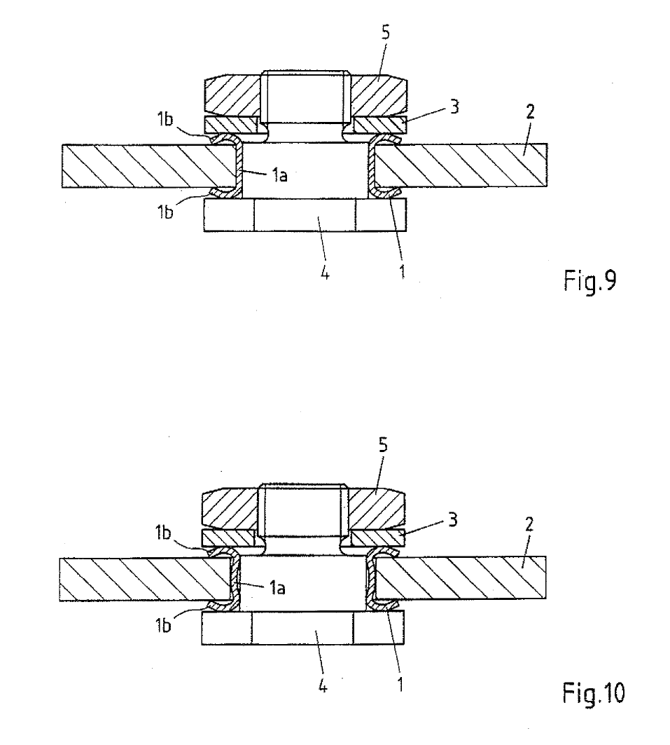

FIG. 9 shows a bearing assembly according to the invention where axial tolerance compensation is achieved; and

FIG. 10 shows a bearing assembly according to the invention where both axial and radial tolerance compensation are achieved.

The prior art bearing bush 1′ shown in FIG. 1 has a cylindrical bush section 1a′ and a V-shaped flange 1b′ on one axial end of the bush section 1a′. When integrated into a bearing assembly (not shown) the V-shaped flange 1b′ of the bearing bush 1′ according to prior art acts as a spring and thus aids to compensate tolerances in axial direction. A radial tolerance compensation is, however, not possible.

FIG. 2a shows a bearing bush 1 according to the invention. The bearing bush 1 comprises a cylindrical bush section 1a and one radial flange 1b arranged on the axial upper end of the bush section 1a. As can be seen in FIG. 2a and especially in FIG. 2b the flange 1b has a mushroom shaped cross section so as to allow axial or axial and radial tolerance compensation in a bearing assembly, which will be explained below with reference to FIGS. 10 and 11.

The mushroom shape allows the flange 1b to act as a spring washer thus compensating for axial clearance through spring back effect. This mushroom shape of the flange's cross section further allows also to prestress and partly deform the bearing bush 1 on its cylindrical surface during assembly.

The composition of the bearing material the bearing bush 1 is made of is not shown in detail in FIG. 2. Preferably, the bearing material is a sliding bearing material comprising a metallic support and an overlay as the sliding layer, wherein the metallic support presently consists of steel or aluminium. The overlay material presently contains a plastic material, preferably a high-temperature fluoroplastic material, especially Polytetrafluorethylene. The sliding bearing material may further comprise a reinforcement material with an open structure, such as a fabric, in particular a wire mesh, an expanded metal, a fleece, in particular a metal fleece, a metal foam, a perforated plate and/or a metallic substrate and a series of raised structures formed integrally therewith and extending orthogonally therefrom.

As can be seen in FIG. 2a the bearing bush 1 according to the invention is a wrapped bush shaped from an initially flat bearing material. The bearing bush 1 has an axial slit 1c wherein the slit is inclined relative to the longitudinal axis of the bearing bush 1 at an angle of approximately 10°. In order to facilitate insertion of the bearing bush 1 into a housing the bearing bush 1 has a tapered end section 1a* on the axial end of the bush section 1a opposing the flange 1b.

As mentioned above the bearing bush 1 according to the invention allows for both axial and radial tolerance compensation in a bearing assembly. An exceptionally effective tolerance compensation may be achieved when the ratio of the height h of the mushroom cross section, i.e. the extent of the mushroom cross section in the longitudinal direction of the bearing bush, and the thickness t of the bearing material is 1.5 to 2 (see FIG. 2b). A bush bearing 1 according to the invention that has a material thickness of approx. 0.5 mm and a height h of the mushroom cross section of approx. 0.75 mm may allow for a tolerance compensation of 0.1-0.3 mm.

In FIG. 4 through 8 a method for producing of a bearing bush 1 according to the invention is shown. The method is carried out using a bordering tool, which will be described in detail with reference to FIG. 5.

According to invention the forming tool for producing a flange 1b on an axial end of a bearing bush having an cylindrical bush section 1a comprises a forming mandrel 6 and a counter tool 7. The forming mandrel 6 has a circumferential shoulder 6b (dead stop) and an axial front section 6a having a reduced diameter radially limited by the shoulder 6b. In turn, the counter tool 7 has a cylindrical inner surface 7a surrounding the cylindrical bush section 1a of the bearing bush 1 to be formed. Further, the counter tool 7 has an annular end face 7b. According to the invention the circumferential shoulder 6b of the forming mandrel 6 and the annular end face 7b of the counter tool 7 are formed such that the flange 1b of the bearing bush 1 is formed with a mushroom shaped cross section. In particular, the circumferential shoulder 6b of the forming mandrel 6 comprises a concave annular face 6b′ and a surrounding flat ring area 6b″ serving as a dead stop during the bordering process. Correspondingly, the annular end face has a convex annular face 7b′ surrounded by a flat ring area 7b″ as counter face relative to the flat ring area 6b″.

Prior to forming the yet cylindrical bearing bush 1* is inserted into the counter tool 7 so as to be encompassed by the cylindrical inner surface 7a of the counter tool 7. The end section of the bearing bush 1* to be formed projects from the upper end of the cylindrical inner surface 7a and the convex annular face 7b′ of the counter tool 7, respectively. After insertion of the bearing bush 1* the forming mandrel 6 is moved towards the counter tool 7 such that the axial front section 6a of the forming mandrel 6 whose outer diameter corresponds to the inner diameter of the bearing bush 1* to be formed plunges into the bearing bush 1*. The forming mandrel 6 continues its movement such that the concave annular face 6b′ forces the projecting end section of the bearing bush 1* to expand outwardly. As the plunger 6 moves further into the counter tool 7 the expanding end section of the bush bearing 1* contacts the convex ring area 7b′ of the counter tool 7 and is eventually forced to attain the mushroom shape of the annular gap defined between the annular faces 6b′, 7b′. The desired thickness is set by the contact of the dead stop 6b″ and the flat ring area 7b″ as can be seen in FIG. 5.

After completion of the first forming step the bush bearing 1 now having one flange 1b with a mushroom cross section is removed from the counter tool 7 and inserted into a bearing housing 2′. The flange 1b is secured by a second counter tool 8 having a concave annular face 8b′ and a dead stop 8b″ such that during the following second forming step the mushroom shape will not be altered (see FIG. 6). The end section of the bearing bush 1 opposing the flange 1b projects from the housing 2′ and faces the forming mandrel 6. For forming the second flange the forming mandrel 6 moves towards the bush bearing 1 and plunges into it whereby the concave annular face 6b′ forces the projecting end section of the bearing bush 1 to expand outwardly as can be seen in FIG. 7. As the forming mandrel 6 moves further into the bearing bush 1 the mushroom shape preset by the concave annular face 6b′ of the forming mandrel is imposed upon the expanding end section of the bush bearing 1. The movement of the plunger 6 which contacts a cylindrical inner surface 8a of the second counter tool 8 is terminated by the dead stop ring area 6b″ abutting the housing 2′. Finally, the housing 2′ and the bearing bush 1 now being secured to the housing 2′ (see FIG. 8) are removed from the bordering tool.

In FIG. 9 a bearing assembly according to the invention is shown. It comprises a first housing 2, which may belong to a component of an automotive seat (not shown), for example the bottom part of the seat, and a second housing 3, which in turn may belong to another component of an automotive seat, for example the seat's back rest. Furthermore, the bearing assembly comprises a bearing bush 1 which has a flange 1b having a mushroom shaped cross section on each of its axial ends. A screw 4 is inserted into the bearing bush 1 and fastened by a screw nut 5 thus securing the bearing assembly. As can be seen in FIG. 10 the nut 5 is screwed onto the screw 4 such that the flanges 1b of the bearing bush 1 are slightly squeezed by the screw head and the housing 3, respectively. The bush bearing 1 according to FIG. 9 thus allows for axial tolerance compensation in the bearing assembly.

Another bearing assembly according to the invention is shown in FIG. 10. It differs from the one shown in FIG. 9 in that the outer diameter of the screw 4 is slightly less than the inner diameter of the first housing 2 such that there is radial clearance between the screw 4 and the housing 2. As the nut 5 is screwed onto the screw 4 the cylindrical bush section 1a is deformed such that it attains a wavy shape as can be seen in FIG. 10. At the same time the flanges 1b of the bearing bush 1 are slightly squeezed by the screw head and the housing 3 as in the case of FIG. 9. Thereby, the bush bearing 1 according to FIG. 10 allows for both axial and radial tolerance compensation in the bearing assembly.

1. A bearing bush comprising an essentially cylindrical bush section and at least one radial flange arranged on an axial end of said cylindrical bush section, wherein the at least one flange has a mushroom shaped cross section so as to allow axial and radial tolerance compensation in a bearing assembly.

2. The bearing bush according to claim 1, wherein the bearing bush is made of a sliding bearing material.

3. The bearing bush according to claim 2, wherein the sliding bearing material comprises a metallic support and an overlay forming the sliding layer.

4. The bearing bush according to claim 3, wherein the overlay contains a plastic material as a sliding material.

5. Bearing bush according to claim 2, wherein the metallic support includes steel, copper, titanium, bronze, aluminum, or an alloy thereof.

6. The bearing bush according to claim 2, wherein the sliding bearing material further comprises a reinforcement material.

7. The bearing bush according to claim 6, wherein the reinforcement material has an open structure.

8. The bearing bush according to claims claim 7, wherein the reinforcement material having an open structure is a fabric, a wire mesh, an expanded metal, a fleece, in particular a metal fleece, a metal foam, a perforated plate, or a metallic substrate and a series of raised structures formed integrally therewith and extending orthogonally therefrom.

9. The bearing bush according to claim 6 wherein the reinforcement material includes metal.

10. The bearing bush according to claim 1, wherein the bearing bush is a wrapped bearing bush having an axial slit.

11. The bearing bush according to claim 10, wherein the axial slit is inclined with respect to a longitudinal axis of the bearing bush, or the axial slit has a Z-shape or an omega shape.

12. (canceled)

13. The bearing bush according to claim 1, wherein the bearing bush is deep-drawn.

14. The bearing bush according to claim 1, wherein the bearing bush has a flange with a mushroom shaped cross section on one axial end of the bush section and a tapered end section on the other axial end so as to facilitate insertion of the bearing bush into a housing.

15. The bearing bush according to claim 1, wherein the bearing bush has two flanges in assembled condition, each having a mushroom shaped cross section and each being disposed on one axial end of the bush section.

16. The bearing bush according to claim 1, wherein the ratio of the height of the mushroom shaped cross section and the thickness of the bearing material is 1.5 to 2.

17. (canceled)

18. The bearing bush according to claim 1, wherein the ratio of the flange diameter and the inner diameter of the bush section is >1.0.

19. A bearing assembly comprising:
at least one housing;
a bearing pin; and
the bearing bush of claim 1, wherein the bearing bush is disposed between the at least one housing and the bearing pin.

20. The bearing assembly according to claim 19, wherein the bearing pin is a screw-nut assembly, a shear tension bolt assembly, or a rivet assembly.

21-22. (canceled)

23. An automotive component comprising at least one bearing assembly according to claim 19, wherein the automotive component is an automotive seat, an automotive door hinge, an automotive trunk or hood hinge, an automotive windshield wiper arm hinge, an automotive belt tensioner, or an automotive pedal hinge.

24-28. (canceled)

29. A forming tool for producing a flange on an axial end of a bearing bush having a cylindrical bush section, wherein the forming tool comprises a forming mandrel having a circumferential shoulder and an axial front section having a reduced diameter and a counter tool having a cylindrical inner surface surrounding the cylindrical bush section of the bearing bush to be bordered, wherein the counter tool has an annular end face serving as stop face for the plunger, wherein the circumferential shoulder of the plunger and the annular end face of the counter tool are formed such that the flange of the bearing bush is formed with a mushroom shaped cross section.
